(19) United States
(12) Patent Application Publication
(10) Pub. No.: US 2007/0011887 A1
(43) Pub. Date: Jan. 18, 2007

(54) FORK APPARATUS

(76) Inventor: Pavan A. Baron, Tucson, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/457,539

(22) Filed: Jul. 14, 2006

Related U.S. Application Data
(60) Provisional application No. 60/699,536, filed on Jul. 15, 2005.

(51) Int. Cl. A47J 43/28

(52) U.S. Cl. 30/322

(57) ABSTRACT

A fork apparatus is disclosed. The fork apparatus comprises a handle, a member slidably disposed within that handle, a fork body, a plurality of fork tines extending outwardly from the fork body, and a push plate slidably disposed on the fork tines. A push rod is attached to the slideable member and to the push plate.

### CROSS-REFERENCE TO RELATED APPLICATIONS

This Application claims priority from a U.S. Provisional Application having Ser. No. 60/699,536 filed Jul. 15, 2005.

### FIELD OF THE INVENTION

This invention relates to fork apparatus. More specifically, the invention relates to a fork apparatus comprising a plurality of fork tines and a moveable push plate slideable disposed over that plurality of fork tines.

### BACKGROUND OF THE INVENTION

When preparing food, it is often necessary to remove a food item from a hot cooking surface. After removing the food item from the hot cooking surface with a fork device, it can be difficult to remove the hot food item from the fork.

What is needed is a fork apparatus that comprises a moveable push plate slideable disposed over the fork tine elements of the fork to facilitate removing a food items therefrom.

### SUMMARY OF THE INVENTION

Applicant's invention comprises a fork apparatus. The fork apparatus comprises a handle having a first end, a second end, and a top surface, where that handle is formed to include a first aperture extending inwardly through the top surface, and where the handle is further formed to include a second aperture extending inwardly from the first end to, and in communication with, the first aperture. The fork apparatus further comprises a member slidably disposed within, and extending outwardly from, the first aperture, and a push rod comprising a first end and a second end, and slidably disposed within the second aperture, where the first end of the push rod is attached to the slideable member, and where the second end of said push rod extends outwardly from the second aperture.

The fork apparatus further comprises a fork body comprising a proximal end and a distal end, where the proximal end is attached to the handle, and where the distal end extends outwardly from the handle. The fork apparatus further comprises a plurality of fork tines extending outwardly from the distal end of the fork body, and a push plate slidably disposed on that plurality of tines, where the second end of the push rod is attached to the push plate.

### BRIEF DESCRIPTION OF THE DRAWINGS

The invention will be better understood from a reading of the following detailed description taken in conjunction with the drawings in which like reference designators are used to designate like elements, and in which:

FIG. 1A is a perspective view of Applicant's fork apparatus;

FIG. 1B is a cross-sectional view of the handle core portion of Applicant's fork apparatus;

FIG. 1C shows the handle core portion of FIG. 1B in combination with an outer surface portion;

FIG. 2A is a cross-sectional view showing Applicant's fork apparatus in a first configuration;

FIG. 2B is a cross-sectional view showing Applicant's fork apparatus in a second configuration;

FIG. 3A is a perspective view of the push plate element of the apparatus of FIG. 1A;

FIG. 3B is a front view of the push plate of FIG. 3A;

FIG. 4A is a top view of a first embodiment of the fork tine elements of the apparatus of FIG. 1A; and

FIG. 4B is a top view of a second embodiment of the fork tine elements of the apparatus of FIG. 1A.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

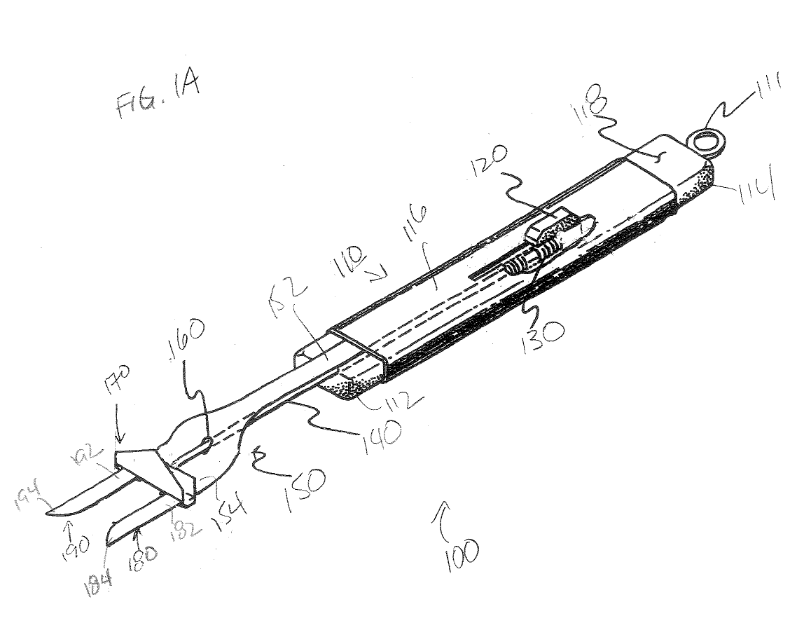

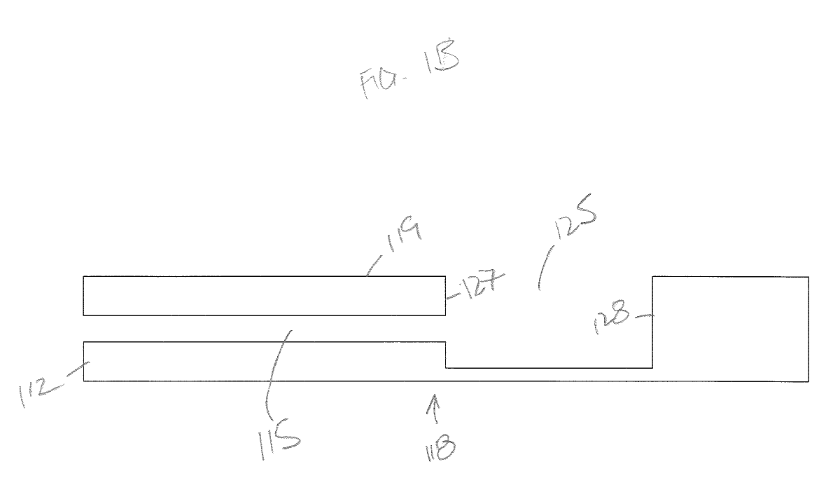

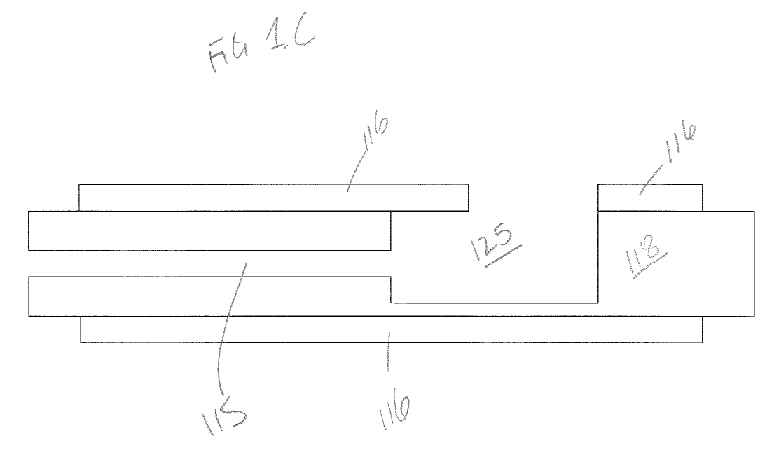

Referring now to FIG. 1A, Applicant's fork apparatus 100 comprises handle 110 comprising first end 112 and second end 114 and fork body 150 comprising proximal end 152 and distal end 154, wherein proximal end 152 is attached to, and extends outwardly from, first end 112 of handle 110. Fork tines 180 and 109 are attached to, and extend outwardly from, distal end 154 of fork body 150. In certain embodiments, fork body 150 and fork tunes 180 and 190 are integrally formed. In the illustrated embodiment of FIG. 1, eyelet 111 is disposed on second end 114 of handle 110.

In the illustrated embodiment of FIG. 1A, fork handle 110 comprises outer surface 116 and handle core 118. In certain embodiments, handle surface 118 is formed from wood, plastic, leather, one or more metals, such as and without limitation aluminum, copper, bronze, steel, polymeric foam, metal foam, combinations thereof, and the like. In certain embodiments, handle core 118 is formed from wood, polymeric foam, metal foam, combinations thereof, and the like. In certain embodiments, outer surface 116 and core 118 are formed from a polymeric foam comprising a thermal conductivity λ of less than 0.10 Watt per meter degree Kelvin (W/m K). In certain embodiments, outer surface 116 and/or core 118 comprise the same material. In certain embodiments, outer surface 116 and core 118 comprise an integral assembly.

Referring now to FIGS. 1B and 1C, handle core 118 is formed to include a first aperture 125 extending inwardly through top portion 119. Core 118 is further formed to include second aperture 115 extending inwardly from first end 112 to communicate with first aperture 125. Outer surface 116 is disposed on handle core 118 such that a portion of aperture 125 is covered.

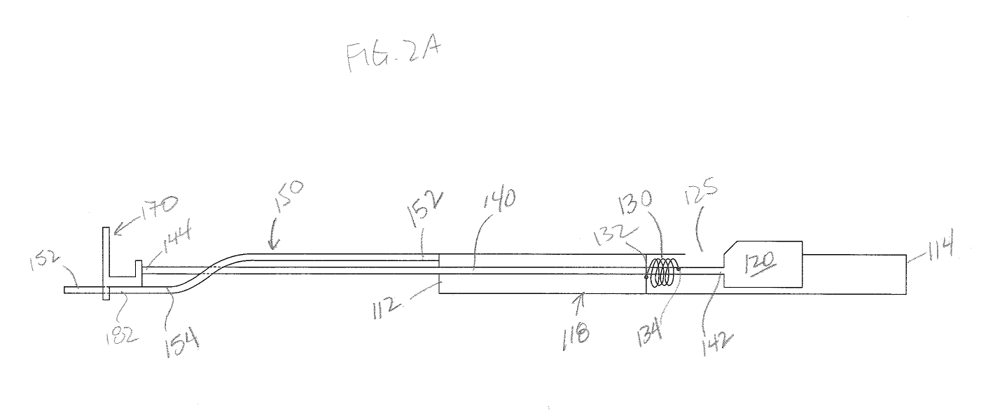

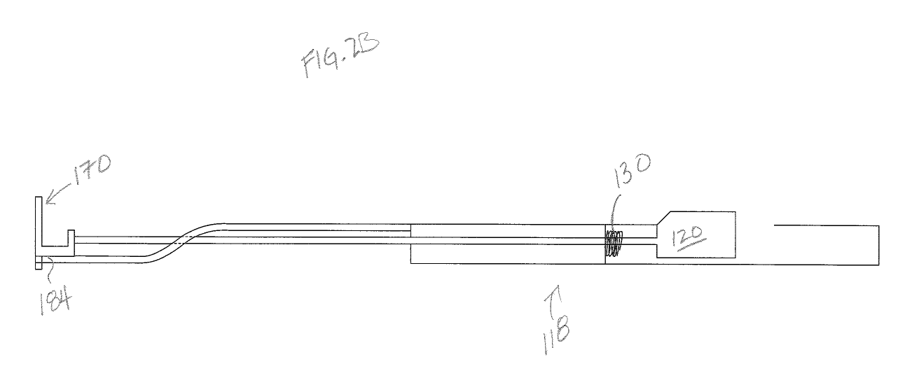

Referring again to FIGS. 1A, 1B, 1C, and 2A, slideable member 120 is slidably disposed within aperture 125. Push rod 140 comprises first end 142 and second end 144. A first portion of push rod is slidably disposed within aperture 115, wherein first end 142 of push rod 140 is attached to slideable member 120. A second portion of push rod 140 extends outwardly from aperture 115, wherein second end 144 of push rod 140 is attached to push plate 170. Spring 130 comprises a first end 132 and a second end 134. First end 132 of spring 130 is disposed against the front wall 127 of aperture 125, and second end 134 of spring 130 is attached to push rod 140. In certain embodiments, first end 132 of spring 130 is attached to handle core 118. In the illustrated embodiment of FIGS. 1A, 2A, and 2B, spring 130 is wound around push rod 140.

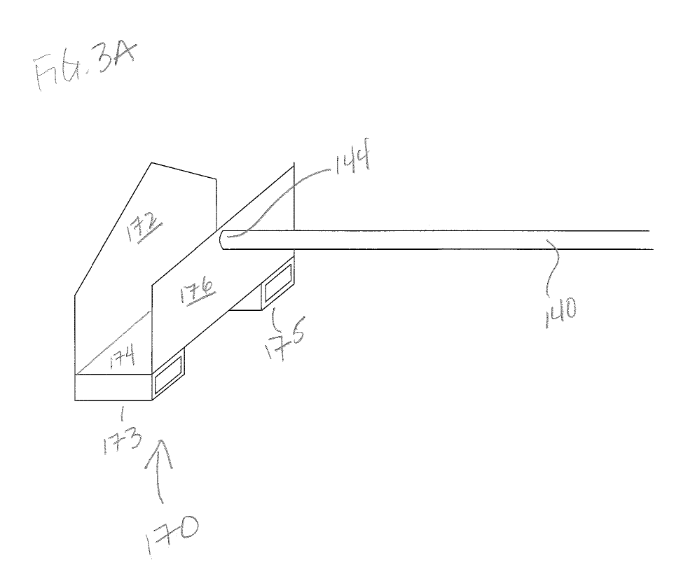

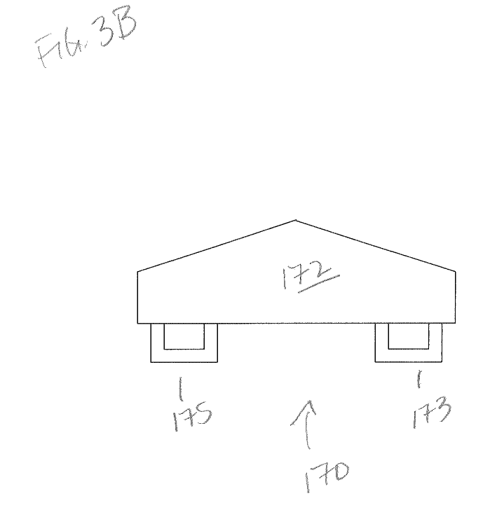

In the illustrated embodiment of FIGS. 1A and 3A, push plate 170 comprises a floor portion 174, member 172 which is attached to a first end of floor 174 and extends upwardly therefrom, and member 176 which is attached to a second end of floor 174 and extends upwardly therefrom. In certain embodiments, push plate 170 is integrally formed to comprise member 172, floor 174, and member 176. Second end 144 of push rod 140 is attached to member 176.

Referring now to FIGS. 3A and 3B, push plate 170 further comprises guide channels 173 and 175. Guide channel 173 comprises a U-shaped member attached to a first side of the bottom portion of floor 174. Guide channel 175 comprises a U-shaped member attached to a second side of the bottom portion of floor 174. Referring now to FIGS. 1A, 3A, and 3B, fork time 180 is disposed within guide channel 173, and fork time 190 is disposed within guide channel 175.

Referring once again to FIGS. 1A, 1B, and 2A, spring 130 urges push rod 140 in a first direction, i.e. backwardly, with a first force such that slideable member 120 is pushed against read wall 128 (FIG. 1B) of aperture 125. In the configuration of FIG. 2A, slide plate 170 is disposed over proximal portions 182 and 192 of fork tines 180 and 190, respectively.

Referring now to FIGS. 1A, 1B, and 2B, if a second force greater than the first force is manually applied in a second direction opposite to that first direction, i.e. forwardly, on slideable member 120, that slideable member 120 can be moved within aperture 125 until slideable member contacts front wall 127 (FIG. 1B) of aperture 125. In the configuration of FIG. 2B, push plate 170 is disposed over distal portions 184 and 194 of fork tines 180 and 190, respectively. When the second force is released from slideable member 120, spring 130 pushes member 120 and push rod 140 backwardly, thereby returning Applicant's fork apparatus to the configuration of FIG. 2A.

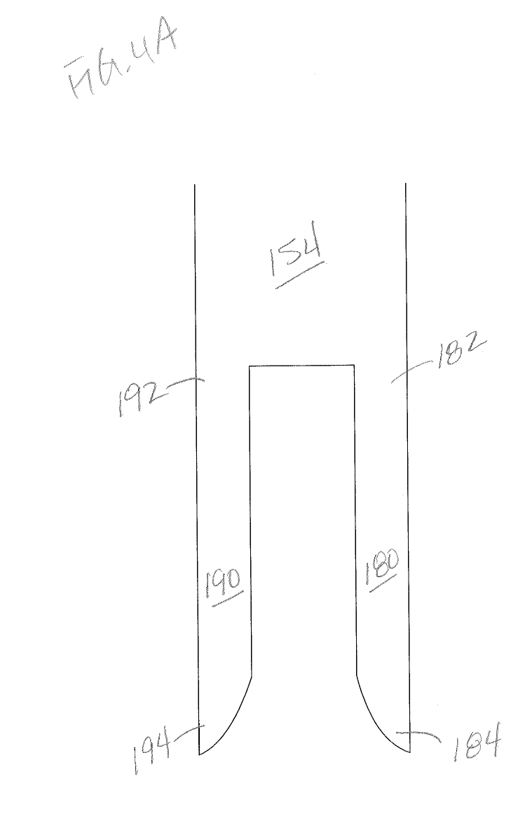

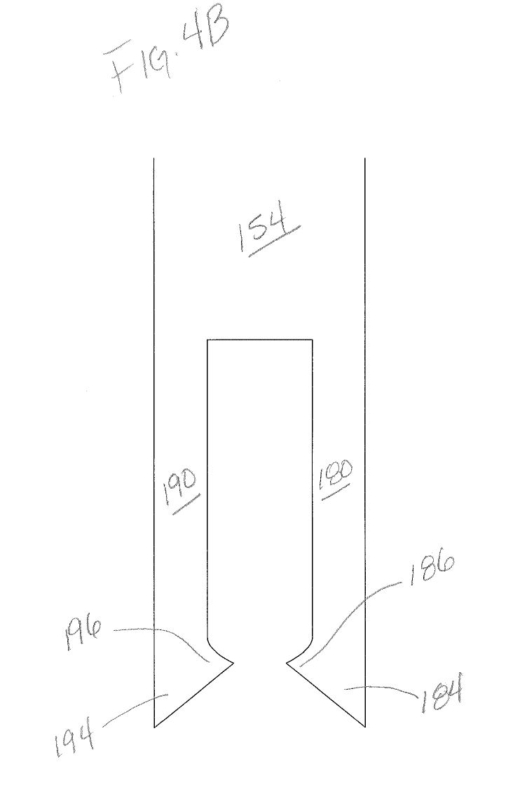

Referring now to FIG. 4A, in certain embodiments the distal ends 184 and 194 of fork tines 180 and 190 are tapered to facilitate insertion of those fork tines into a food item, such as a portion of meat, chicken, fish, and the like. Referring now to FIG. 4B, in certain embodiments distal ends 184 and 194 of fork tines 180 and 190 are further formed to comprise a barbed element 186 and 196 respectively, to prevent premature release of an affixed food item.

In use, distal end portions 184 and 194 of fork tines 180 and 190, respectively, are inserted into a food item to, for example, remove that food item from a cooking surface. When slideable member 120 is urged forward, guide channels 173 and 175 slide forwardly over fork tines 180 and 190, respectively, and push plate 170 is moved to the distal ends 184 and 194 of fork tines 180 and 190, respectively, thereby pushing the affixed food item from Applicant's fork apparatus.

While the preferred embodiments of the present invention have been illustrated in detail, it should be apparent that modifications and adaptations to those embodiments may occur to one skilled in the art without departing from the scope of the present invention as set forth in the following claims.

I claim:

1. A fork apparatus, comprising:
a handle comprising a first end, a second end, and a top surface, wherein said handle is formed to include a first aperture extending inwardly through said top surface, and wherein said handle is further formed to include a second aperture extending inwardly from said first end and through a portion of said handle to communicate with said first aperture;
a member slidably disposed within, and extending outwardly from, said first aperture;
a push rod slidably comprising a first end and a second end, wherein a portion of said push rod is slidably disposed within said second aperture, wherein said first end of said push rod is attached to said slideable member, and wherein said second end of said push rod extends outwardly from said second aperture;
a fork body comprising a proximal end and a distal end, wherein said proximal end is attached to a said first end of said handle, and wherein said distal end extends outwardly from said first end of said handle;
a plurality of fork tines extending outwardly from said distal end of said fork body;
a push plate slidably disposed on said plurality of tines, wherein said second end of said push rod is attached to said push plate.

2. The fork apparatus of claim 1, wherein said handle comprises an outer surface and a core.

3. The fork apparatus of claim 2, wherein said outer surface is formed from a material selected from the group consisting of wood, plastic, leather, and metal.

4. The fork apparatus of claim 2, wherein said core is formed from a polymeric foam.

5. The fork apparatus of claim 4, wherein said polymeric foam comprises a thermal conductivity λ of less than 0.10 Watt per meter degree Kelvin (W/m K).

6. The fork apparatus of claim 2, wherein said outer surface covers a portion of, but not all of, said core.

7. The fork apparatus of claim 1, further comprising an eyelet disposed on said second end of said handle.

8. The fork apparatus of claim 1, wherein said fork body further comprises a plurality of alignment channels, wherein each of said plurality of fork tines is slidably disposed through a different one of said plurality of alignment channels

9. The fork apparatus of claim 1, further comprising:
a spring comprising a first end and a second end, wherein said spring is disposed within said handle, and wherein said first end of said spring is attached to said handle and wherein said second end of said spring is attached to said push rod.

10. The fork apparatus of claim 9, wherein said spring is wound around said push rod.

11. The fork apparatus of claim 9, wherein:
each of said plurality of fork tines comprises a proximal end attached to said fork body and a distal end extending outwardly therefrom;
said first aperture is defined by a front wall and a rear wall;
said spring urges said push rod in a first direction such that said slideable member contacts said read wall of said first aperture, thereby positioning said push plate at the proximal end of each of said plurality of fork tines;
moving said slideable member in a second direction opposite to said first direction such that said slideable member contacts said front wall of said first aperture positions said push plate at the distal end of each of said plurality of fork tines.
